(19) United States
(12) Patent Application Publication
(10) Pub. No.: US 2026/0359262 A1
(43) Pub. Date: Nov. 12, 2026

(54) DATA PROCESSING SYSTEM AND DATA PROCESSING METHOD

(71) Applicant: Hitachi Vantara, Ltd., Kanagawa-ken (JP)

(72) Inventors: Mitsuo HAYASAKA, Tokyo (JP); Yuto KAMO, Tokyo (JP)

(21) Appl. No.: 19/545,911

(22) Filed: Feb. 20, 2026

(30) Foreign Application Priority Data
May 8, 2025 (JP) 2025-077914

(51) Int. Cl. G06F 16/11; G06F 16/182; G06F 21/62

(52) U.S. Cl. CPC G06F 16/128; G06F 16/183; G06F 21/6254

(57) ABSTRACT

A data processing system including one or more storage servers that store files and a data management server that executes a process on the files includes one or more processors, in which the one or more processors store respective operation contents for the files in the storage server as an operation log, create a snapshot of a file system in the storage server, extract, from the operation log, the operation content performed from creation of a previous snapshot to a current snapshot, and create an update file list capable of specifying a file updated after the creation of the previous snapshot based on the extracted operation content.

### CROSS-REFERENCE TO RELATED APPLICATIONS

This application is based upon and claims the benefit of priority from Japanese Patent Application No. 2025-077914, filed in Japan Patent Office on May 8, 2025, the contents of which are hereby incorporated by reference.

### BACKGROUND OF THE INVENTION

### 1. Field of the Invention

The present invention relates to a technique for managing files stored in a storage server.

### 2. Description of Related Art

In recent years, in data utilization, there have been an increasing number of cases in which data in a plurality of on-premises sites is moved and duplicated to a site having a large amount of calculation resources to perform processing, learning, and the like. At the same time, regional regulations for prohibiting leakage of sensitive data such as personal information to an outside of a region have been strengthened.

In order to solve these problems, PTL 1 discloses a technique for detecting the sensitive data such as the personal information and preventing the sensitive data from leaking out of a region.

### CITATION LIST

### Patent Literature

PTL 1: JP2024-085152A

### SUMMARY OF THE INVENTION

In the technique of PTL 1, it is possible to avoid data leakage to the outside of the region. However, there is a problem that it takes time to detect the sensitive data.

For example, after the sensitive data is detected once for all file data in a file object storage, the sensitive data is detected only for newly created data or updated data, thereby reducing a detection time for the sensitive data.

In this case, for example, in a sensitive data detection process, update dates and times of all the files stored in the file object storage may be checked, files updated after the sensitive data is previously detected may be extracted, and the sensitive data detection process may be applied to these files.

In order to perform the process, it is necessary to check the update dates and times of all the large number of files stored in the file object storage, which takes time.

The invention has been made in view of the above circumstances, and an object thereof is to provide a technique capable of quickly specifying an updated file.

In order to achieve the above object, a data processing system according to one aspect is a data processing system including one or more storage servers that store files, and a data management server that executes a process on the files, the data processing system including one or more processors, in which the one or more processors store respective operation contents for the files in the storage servers as an operation log, create a snapshot of a file system in the storage servers, extract, from the operation log, the operation content performed from creation of a previous snapshot to a current snapshot, and create update file information capable of specifying a file updated after the creation of the previous snapshot based on the extracted operation content.

According to the invention, it is possible to quickly specify an updated file.

### BRIEF DESCRIPTION OF THE DRAWINGS

FIG. 1 is an overall configuration diagram showing a data processing system according to a first embodiment;

FIG. 2 is a configuration diagram showing a data management server according to the first embodiment;

FIG. 3 is a configuration diagram showing a storage server according to the first embodiment;

FIG. 4 is a configuration diagram showing an operation log according to the first embodiment;

FIG. 5 is a configuration diagram showing a snapshot list according to the first embodiment;

FIG. 6 is a configuration diagram showing an update file list according to the first embodiment;

FIG. 7 is a flowchart of a client I/O process according to the first embodiment;

FIG. 8 is a flowchart of a data extraction and processing control process according to the first embodiment;

FIG. 9 is a flowchart of an update file list creation process according to the first embodiment;

FIG. 10 is a configuration diagram showing an operation log according to a second embodiment;

FIG. 11 is a configuration diagram showing an update file list according to the second embodiment;

FIG. 12 is a flowchart of a data extraction and processing control process according to the second embodiment;

FIG. 13 is a configuration diagram showing a data management server according to a third embodiment;

FIG. 14 is a configuration diagram showing a storage server according to the third embodiment; and

FIG. 15 is a flowchart of a data extraction and processing control process according to the third embodiment.

### DESCRIPTION OF EMBODIMENTS

Embodiments will be described with reference to the drawings. The embodiments to be described later do not limit the invention according to the claims, and all of the various elements described in the embodiments and the combinations thereof are not necessarily essential for the solution of the invention.

In the following description, information may be described by an expression of “AAA list”, whereas the information may be expressed in any data structure. That is, in order to indicate that the information does not depend on the data structure, the “AAA list” can be referred to as “AAA information”.

In addition, in the following description, processing may be described with a “program” as an operation subject, and since the program is executed by a processor to perform determined processing by using at least one of a storage unit and an interface unit as appropriate, the subject of the processing may be the processor (or a computer or a computer system including the processor). The program may be installed on the computer from a program source. The program source may be, for example, a program distribution server or a computer-readable recording medium. In the following description, two or more programs may be implemented as one program, or one program may be implemented as two or more programs. Further, at least a part of the processing implemented by executing the program may be implemented by a hardware circuit (for example, an application specific integrated circuit (ASIC) or a field-programmable gate array (FPGA)).

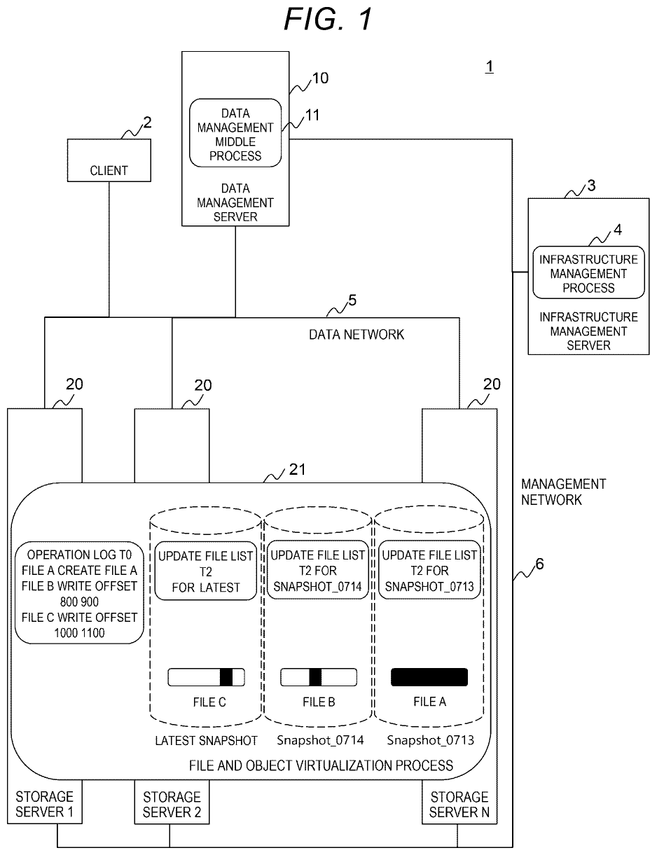

FIG. 1 is an overall configuration diagram showing a data processing system according to a first embodiment.

A data processing system 1 includes a client 2, an infrastructure management server 3, a data management server 10, and one or more storage servers 20. The client 2, the data management server 10, and the storage server 20 are connected via, for example, a data network 5. The data network 5 may be, for example, a local area network (LAN), or a wide area network (WAN). The infrastructure management server 3, the data management server 10, and the storage server 20 are connected via a management network 6. The management network 6 may be, for example, a LAN or a WAN.

The client 2 is, for example, a personal computer (PC), receives an operation request for a file or a directory of a file system from a user, and transmits the operation request to the storage server 20.

The infrastructure management server 3 executes an infrastructure management process 4 for managing an infrastructure including the data management server 10 and the storage server 20.

The one or more storage servers 20 provide one or more file systems. In the present embodiment, a file system is constructed by a cluster including a plurality of storage servers 20, and files are managed by a file and object virtualization process 21.

In the cluster, an operation log T0 that stores an operation content for a file of the file system and a snapshot of the file system at a predetermined time point are managed. Each snapshot includes an update file list T2 (update file information) that can specify a file updated (added, changed, deleted, or the like) from a time of creation of a previous snapshot (when there is no previous snapshot, at an initial time) to a time of creation of the snapshot.

The data management server 10 executes a process of managing data of the storage server 20 by executing a data management middle process 11.

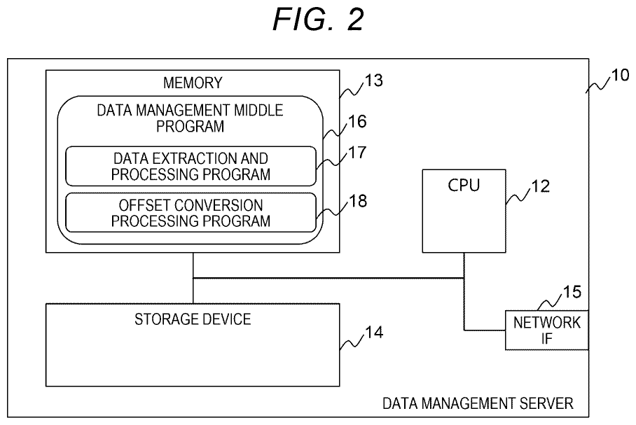

FIG. 2 is a configuration diagram showing a data management server according to the first embodiment.

The data management server 10 includes, for example, a computer such as a PC or a general-purpose server. The data management server 10 includes a central processing unit (CPU) 12, a memory 13, a storage device 14, and a network interface (IF) 15.

The network IF 15 is, for example, an interface such as a wired LAN card or a wireless LAN card, and communicates with other devices (for example, the infrastructure management server 3 and the storage server 20) via the data network 5 and the management network 6.

The CPU 12 is an example of a processor, and executes various processes according to a program stored in the memory 13 and/or the storage device 14.

The memory 13 is, for example, a random access memory (RAM), and stores programs to be executed by the CPU 12 and necessary information. In the present embodiment, the memory 13 stores a data management middle program 16. The data management middle program 16 includes a data extraction and processing program 17 and an offset conversion processing program 18. When being executed by the CPU 12, the data management middle program 16 executes the data management middle process 11. When being executed by the CPU 12, the data extraction and processing program 17 executes a data extraction and processing process that extracts predetermined data (for example, sensitive data) from a file and performs a process of anonymizing the sensitive data. When being executed by the CPU 12, the offset conversion processing program 18 executes an offset conversion process for converting an offset in an operation range in a file. The offset conversion processing program 18 does not function in the first embodiment, but functions in a second embodiment to be described later.

The storage device 14 is, for example, a hard disk or a flash memory, and stores programs to be executed by the CPU 12 and data to be used by the CPU 12. The storage device 14 stores, for example, information on a file including the sensitive data and a processed file obtained by performing processing (anonymization process) of the sensitive data on the file.

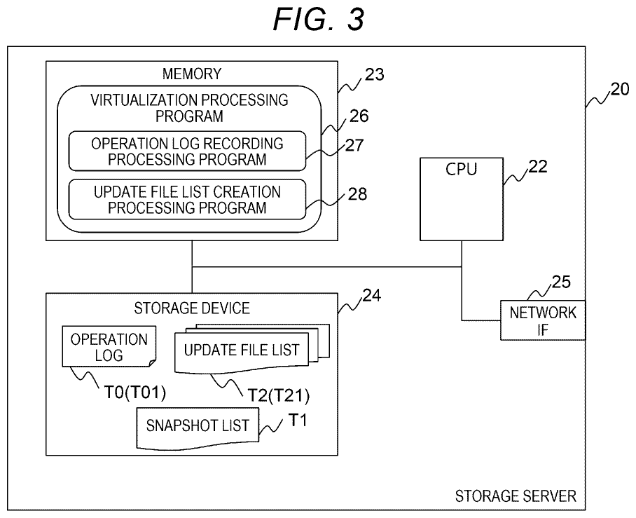

FIG. 3 is a configuration diagram showing a storage server according to the first embodiment.

The storage server 20 includes, for example, a computer such as a general-purpose server. The storage server 20 includes a CPU 22, a memory 23, a storage device 24, and a network IF 25.

The network IF 25 is, for example, an interface such as a wired LAN card or a wireless LAN card, and communicates with other devices (for example, the client 2, the infrastructure management server 3, and the data management server 10) via the data network 5 and the management network 6.

The CPU 22 is an example of a processor, and executes various processes according to a program stored in the memory 23 and/or the storage device 24.

The memory 23 is, for example, a RAM, and stores programs to be executed by the CPU 22 and necessary information. In the present embodiment, the memory 23 stores a virtualization processing program 26. The virtualization processing program 26 includes an operation log recording processing program 27 and an update file list creation processing program 28. When being executed by the CPU 22, the virtualization processing program 26 executes a file and object virtualization process 21 for virtualizing and managing files in the file system. When being executed by the CPU 22, the operation log recording processing program 27 executes an operation log recording process of recording an operation content for the file or the directory as the operation log T0. When being executed by the CPU 22, the update file list creation processing program 28 executes an update file list creation process for creating the update file list T2.

The storage device 24 is, for example, a hard disk or a flash memory, and stores programs to be executed by the CPU 22 and data to be used by the CPU 22. The storage device 24 stores the operation log T0, the snapshot list T1, and the update file list T2. The operation log T0 may be stored in the storage device 24 of any of the plurality of storage servers 20 in the cluster, or may be distributed and stored in the storage devices 24 of the plurality of storage servers 20. The snapshot list T1 and the update file list T2 are stored in the storage device 24 of any of the plurality of storage servers 20.

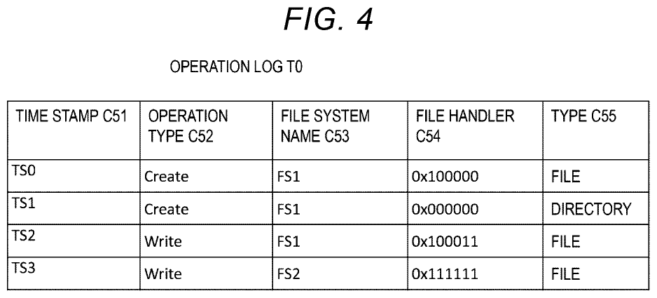

FIG. 4 is a configuration diagram showing an operation log according to the first embodiment.

The operation log T0 stores an entry for each operation content for a file or a directory. The entry of the operation log T0 includes fields of a time stamp C51, an operation type C52, a file system name C53, a file handler C54, and a type C55.

The time stamp C51 stores time information (time stamp) when the operation content corresponding to the entry is performed. The operation type C52 stores a type of an operation of the operation content corresponding to the entry. Examples of the operation type include create, write, and delete. The file system name C53 stores a name (file system name) of the file system targeted by the operation content corresponding to the entry. The file handler C54 stores information for identifying a file or a directory targeted by the operation content corresponding to the entry. The information for identifying a file or a directory may be a file path. The type C55 stores a type of a target object targeted by the operation content corresponding to the entry. The types of target objects include files and directories.

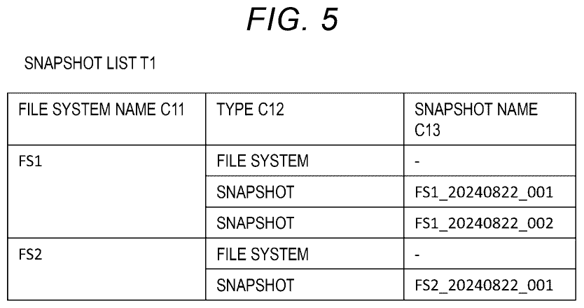

FIG. 5 is a configuration diagram showing a snapshot list according to the first embodiment.

The snapshot list T1 stores entries corresponding to file systems and snapshots in each file system. The entry of the snapshot list T1 includes fields of a file system name C11, a type C12, and a snapshot name C13. The file system name C11 stores a file system name of the file system corresponding to the entry. The type C12 stores a type of the target entry. The types include the file system and the snapshot. When the entry corresponds to a snapshot, the snapshot name C13 stores the name of the snapshot (snapshot name). According to the entry of the snapshot list T1, it is possible to specify a path of metadata of a file system and a path of a snapshot in the file system. For example, a path of metadata of a file system having a file system name of FS1 is “/FS1/.metadata.file”, and a path of a snapshot whose snapshot name of the file system having the file system name of FS1 is “FS1_20240822_001” is “/FS1/.snap/FS 1_20240822_001/.metadata. file”.

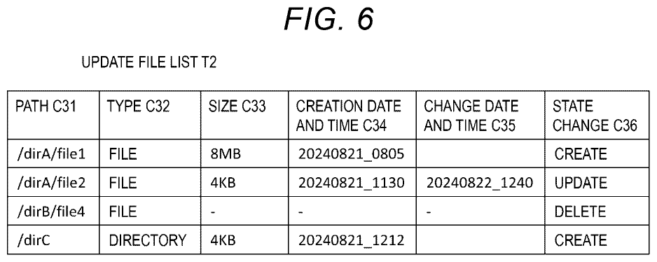

FIG. 6 is a configuration diagram showing an update file list according to the first embodiment.

The update file list T2 stores an entry for each updated operation target (file, directory) for the file system. The entry of the update file list T2 includes a path C31, a type C32, a size C33, a creation date and time C34, a change date and time C35, and a state change C36.

The path C31 stores a path of the operation target (file, directory) corresponding to the entry. The type C32 stores a type of the operation target corresponding to the entry. The size C33 stores a size of the operation target corresponding to the entry. The creation date and time C34 stores a date and time when the operation target corresponding to the entry is created. The change date and time C35 stores a date and time when the operation target corresponding to the entry is changed. The state change C36 stores an operation content for the operation target corresponding to the entry. Examples of the operation content include creation, update, and deletion.

Next, a processing operation of the data processing system 1 will be described.

First, a client I/O process for processing an I/O request from the client 2 in the storage server 20 will be described.

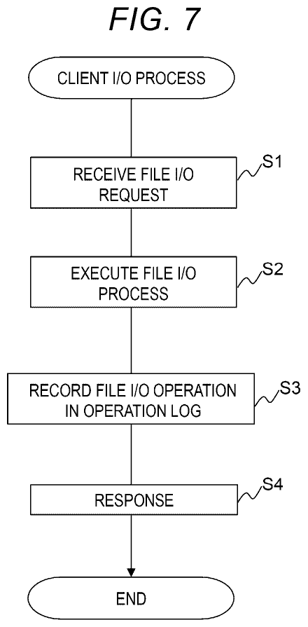

FIG. 7 is a flowchart of a client I/O process according to the first embodiment.

The virtualization processing program 26 (strictly speaking, the CPU 22 that executes the virtualization processing program 26) receives a file I/O request transmitted from the client 2 (S1). The file I/O request includes file creation, file writing, file reading, file deletion, directory creation, directory deletion, and the like. In the case of the file writing, the file writing includes information for specifying a file (a path name or the like) and information of an offset indicating an operation target area in the file.

Next, the virtualization processing program 26 executes a file I/O process corresponding to the file I/O request (S2).

Next, the operation log recording processing program 27 records a file I/O operation content corresponding to the file I/O request in the operation log T0 (S3).

Next, the virtualization processing program 26 transmits a response to the file I/O request to the client 2 (S4).

Next, a data extraction and processing control process will be described.

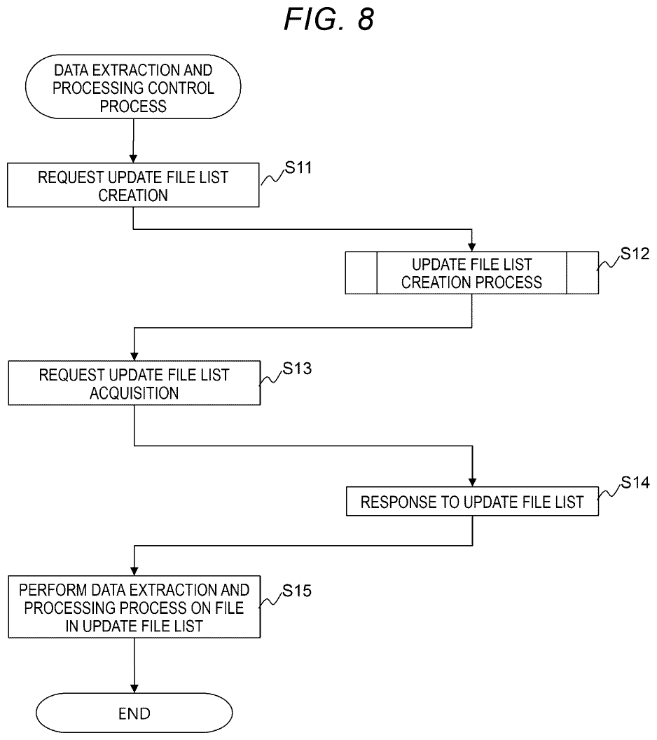

FIG. 8 is a flowchart of a data extraction and processing control process according to the first embodiment.

The data extraction and processing control process may be periodically executed by, for example, a scheduler or the like, or may be executed in accordance with an instruction from the user.

The data extraction and processing program 17 of the data management server 10 (strictly speaking, the CPU 12 that executes the data extraction and processing program 17) transmits an update file list creation request to the storage server 20 (S11). The update file list creation request may include, for example, a file system name of a file system for which an update file list is to be created, or may include contents targeted by all file systems.

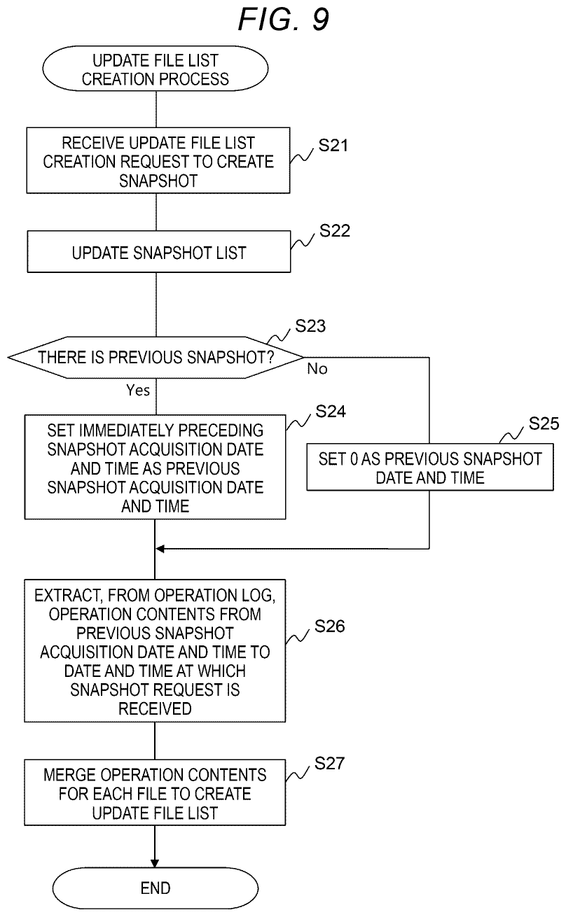

In the storage server 20, the update file list creation processing program 28 executes the update file list creation process (see FIG. 9) to create the update file list T2 (S12).

Next, the data extraction and processing program 17 transmits an acquisition request of the update file list T2 to the storage server 20 (S13).

The update file list creation processing program 28 transmits the created update file list T2 to the data management server 10 (S14).

The data extraction and processing program 17 receives the update file list T2, executes a data extraction process and a data processing process on files included in the update file list T2 as processing targets, and stores the processed files in a predetermined storage device (S15). In the data extraction process, the data extraction and processing program 17 extracts, for example, sensitive data from the files as the processing targets. In addition, in the data processing process, the data extraction and processing program 17 performs the anonymization process on the extracted sensitive data such that an actual content is not specified.

According to the present embodiment, since the files as the processing targets are specified from the update file list T2, the files as the processing targets can be specified quickly. In addition, since the data extraction process and the data processing process are performed only on the files as the processing targets in the update file list T2, a processing load of the data management server 10 can be reduced, and a processing time can be shortened.

Next, the update file list creation process (S12) will be described in detail.

FIG. 9 is a flowchart of an update file list creation process according to the first embodiment.

The update file list creation processing program 28 of the storage server 20 receives the update file list creation request and creates a snapshot (S21).

Next, the update file list creation processing program 28 updates the snapshot list T1 (S22). Specifically, the update file list creation processing program 28 adds an entry of a snapshot of the file system as a current target to the snapshot list T1.

Next, the update file list creation processing program 28 refers to the snapshot list T1 and determines whether there is a previous snapshot in the target file system (S23).

As a result, when there is a previous snapshot (S23: Yes), the update file list creation processing program 28 sets an immediately preceding snapshot acquisition date and time as a previous snapshot acquisition date and time which is a variable (S24), and proceeds the process to step S26. The snapshot acquisition date and time may correspond to a file of the snapshot. On the other hand, when there is no previous snapshot (S23: No), that is, when there is a first snapshot for the file system, the update file list creation processing program 28 sets an initial value (for example, 0) as the previous snapshot acquisition date and time, which is the variable (S25), and proceeds the process to step S26.

In step S26, the update file list creation processing program 28 extracts, from the operation log T0, operation contents from the previous snapshot date and time, which is the variable, to a date and time at which the update file list creation request is received.

Next, the update file list creation processing program 28 merges the acquired operation contents for each file to create the update file list T2 (S27).

According to the update file list creation process, it is possible to create the update file list T2 including only the files operated until the current snapshot is created after the previous snapshot (in the case of first time, an initial state).

Next, a data processing system according to the second embodiment will be described. Since the data processing system according to the second embodiment can have a configuration using the same hardware as the data processing system 1 according to the first embodiment illustrated in FIGS. 2 and 3, each component will be described using the reference numerals in FIGS. 2 and 3 as appropriate, and different portions will be mainly described.

In the data processing system according to the second embodiment, the offset conversion processing program 18 is caused to function, and a function of the data extraction and processing program 17 is partially changed. In the data processing system, an operation log T01 is used instead of the operation log T0, and an update file list T21 is used instead of the update file list T2.

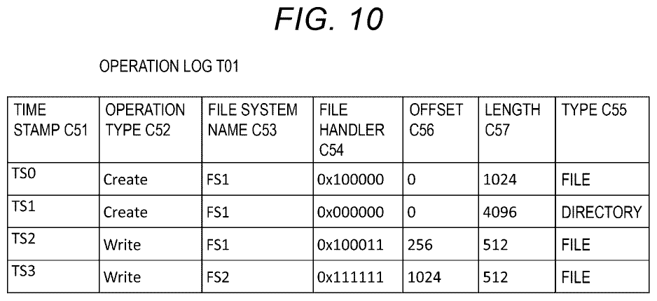

FIG. 10 is a configuration diagram showing an operation log according to the second embodiment.

The operation log T01 further includes fields of an offset C56 and a length C57 for the entry of the operation log T0.

The offset C56 stores an offset indicating a head of a range (operation range) targeted by an operation content corresponding to the entry. The length C57 stores a length of the range targeted by the operation content corresponding to the entry. The offset and the length correspond to offset information.

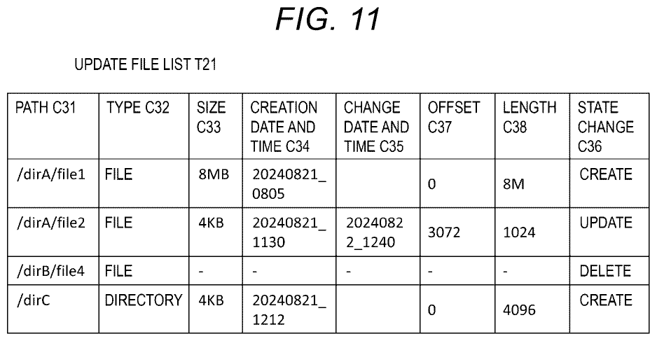

FIG. 11 is a configuration diagram showing an update file list according to the second embodiment.

The update file list T21 further includes fields of an offset C37 and a length C38 for the entry of the update file list T2.

When the offset conversion process is not performed, the offset C37 stores the offset indicating the head of the operation range targeted by the operation content for the file corresponding to the entry, and when the offset conversion process is performed, the offset C37 stores an offset indicating a head of a range (semantic recognizable range) including the operation range targeted by the operation content for the file corresponding to the entry and having a meaning capable of being recognized. Here, the semantic recognizable range is, for example, a range from a head to an end of a row including the operation range when the type of the file is a CSV file, a range including the operation range and surrounded by { } when the type of the file is a JSON file, and a range from a head of a key frame when the type of the file is a moving image file.

The length C38 stores a length of the operation range targeted by the operation content for the file corresponding to the entry when the offset conversion process is not performed, and stores a length of the semantic recognizable range of the file corresponding to the entry when the offset conversion process is performed.

Next, a data extraction and processing control process according to the second embodiment will be described. The data extraction and processing control process may be periodically executed by, for example, a scheduler or the like, or may be executed in accordance with an instruction from the user.

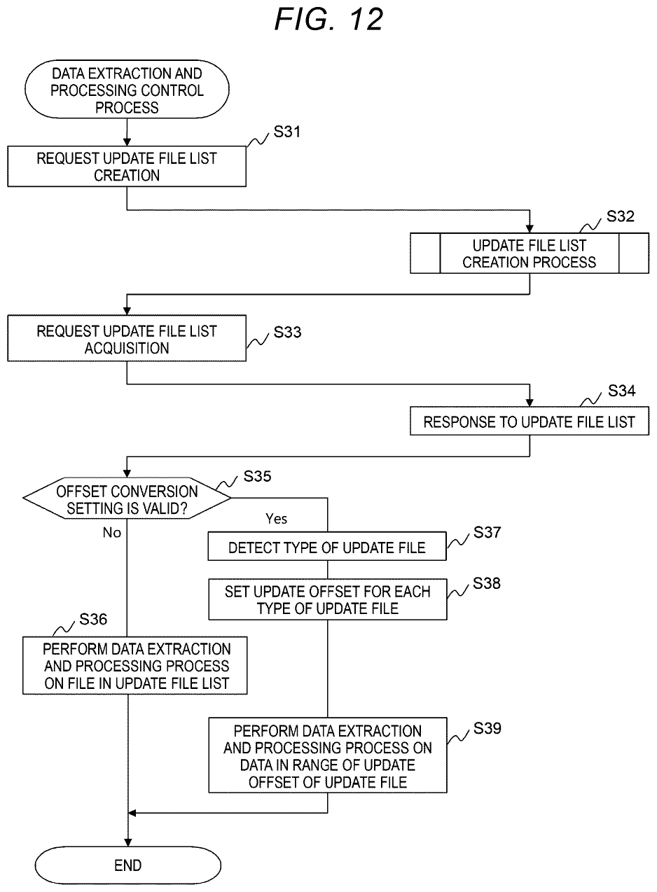

FIG. 12 is a flowchart of the data extraction and processing control process according to the second embodiment.

The data extraction and processing program 17 of the data management server 10 (strictly speaking, the CPU 12 that executes the data extraction and processing program 17) transmits an update file list creation request to the storage server 20 (S31). The update file list creation request may include, for example, a file system name of a file system for which an update file list is to be created.

In the storage server 20, the update file list creation processing program 28 executes the update file list creation process to create the update file list T21 (S32). Here, the update file list creation process is a process in which in the process in FIG. 9, the update file list T21 is created instead of the update file list T2, a head offset of a range obtained by merging the range of the operation target is stored in the offset C37 of the entry of the update file list T21, and a length of the merged range is stored in the length C38.

Next, the data extraction and processing program 17 transmits an acquisition request of the update file list T21 to the storage server 20 (S33).

The update file list creation processing program 28 transmits the created update file list T21 to the data management server 10 (S34).

Next, the data extraction and processing program 17 receives the update file list T21, and the offset conversion processing program 18 determines whether an offset conversion setting is valid (S35). Here, the offset conversion setting can be set in advance by the user.

As a result, when the offset conversion setting is not valid (S35: No), the data extraction and processing program 17 executes the data extraction process and the data processing process with a range designated by the offset and the length of the file included in the update file list T21 as the processing target, and stores the processed file in the predetermined storage device (S36).

On the other hand, when the offset conversion setting is valid (S35: Yes), the offset conversion processing program 18 detects the type of the file included in the update file list T21 (S37), converts the offset and the length for each type of the file into the offset (update offset) and the length corresponding to the semantic recognizable range, sets the offset and the length in the update file list T21 (S38), executes the data extraction process and the data processing process on the range indicated by the update offset of the file, and stores the processed file in the predetermined storage device (S39).

According to the present embodiment, since the data extraction process and the data processing process are executed only for the range indicating the offset and the length of the file of the update file list T21, a processing amount can be reduced as compared with a case where the processes are performed for the entire file. Further, in the present embodiment, when the offset conversion setting is valid, the data extraction process and the data processing process are executed for the semantic recognizable range in which the operation range of the file is expanded, and thus extraction accuracy by the data extraction process can be improved.

Next, a data processing system according to a third embodiment will be described. The data processing system according to the third embodiment is a system in which the offset conversion process in the data processing system according to the second embodiment is executed by the storage server 20. The data processing system according to the third embodiment includes a data management server 10A instead of the data management server 10 according to the first embodiment, and includes a storage server 20A instead of the storage server 20.

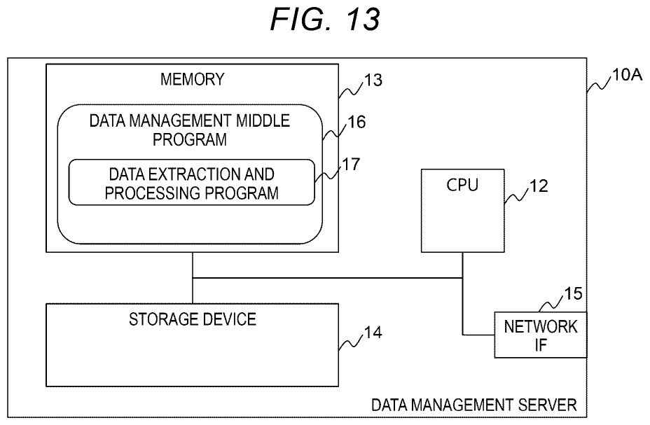

FIG. 13 is a configuration diagram showing a data management server according to the third embodiment. In FIG. 13, the same components as those of the data management server 10 according to the first embodiment are denoted by the same reference numerals.

The data management server 10A has the same hardware as the data management server 10, but does not store the offset conversion processing program 18 in the memory 13.

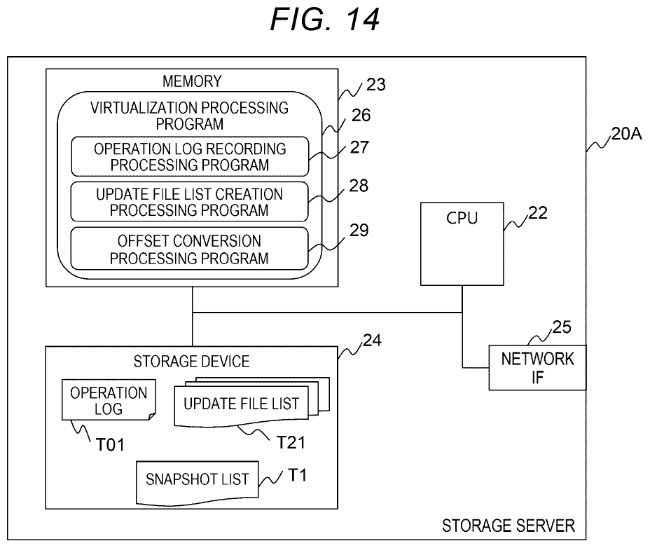

FIG. 14 is a configuration diagram showing a storage server according to the third embodiment. In FIG. 14, the same components as those of the storage server 20 according to the first embodiment are denoted by the same reference numerals.

The storage server 20A has the same hardware as the storage server 20, and further stores an offset conversion processing program 29 in the memory 23. When being executed by the CPU 22, the offset conversion processing program 29 executes an offset conversion process for converting an offset in an operation range in a file.

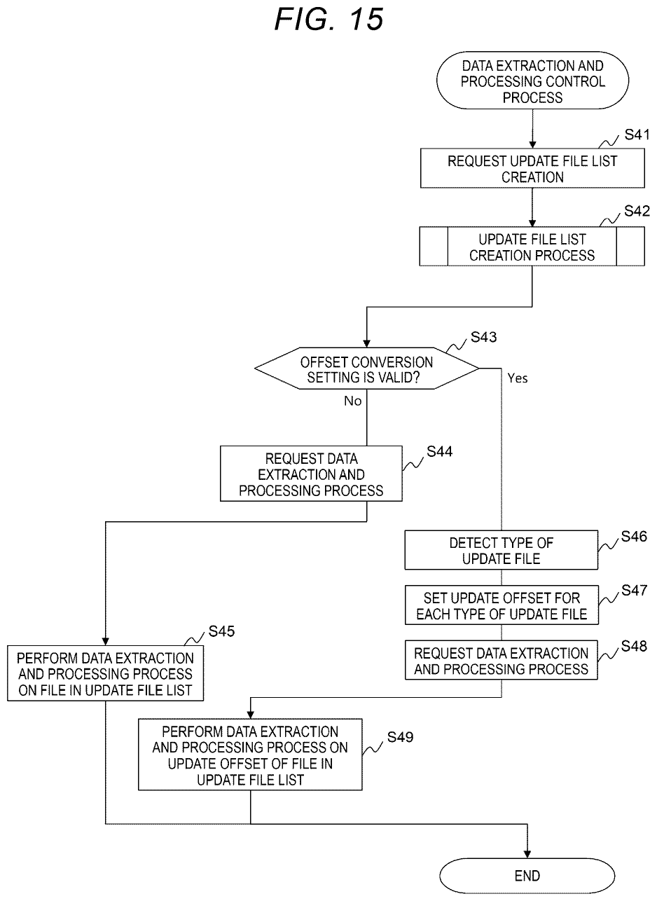

FIG. 15 is a flowchart of a data extraction and processing control process according to the third embodiment. The data extraction and processing control process may be periodically executed by, for example, a scheduler or the like, or may be executed in accordance with an instruction from the data management server 10A or the like.

The virtualization processing program 26 of the storage server 20A (strictly speaking, the CPU 22 that executes the virtualization processing program 26) transmits an update file list creation request to the update file list creation processing program 28 (S41). The update file list creation request may include, for example, a file system name of a file system for which an update file list is to be created.

The update file list creation processing program 28 executes the update file list creation process to create the update file list T21 (S42). Here, the update file list creation process is the same as the process of step S32 in FIG. 12.

Next, the offset conversion processing program 29 determines whether the offset conversion setting is valid (S43). Here, the offset conversion setting can be set in advance by the user.

As a result, when the offset conversion setting is not valid (S43: No), the offset conversion processing program 29 transmits a data extraction and processing process request to the data management server 10A (S44). The data extraction and processing process request includes the update file list T21.

The data extraction and processing program 17 of the data management server 10A executes the data extraction process and the data processing process with a range designated by the offset and the length of the file included in the update file list T21 as the processing target, and stores the processed file in the predetermined storage device (S45).

On the other hand, when the offset conversion setting is valid (S43: Yes), the offset conversion processing program 29 detects the type of the file included in the update file list T21 (S46), converts the offset and the length for each type of the file into the offset (update offset) and the length corresponding to the semantic recognizable range, sets the offset and the length in the update file list T21 (S47), and transmits the data extraction and processing process request to the data management server 10A (S48). The data extraction and processing process request includes the update file list T21.

The data extraction and processing program 17 of the data management server 10A executes the data extraction process and the data processing process on the range indicated by the update offset of the file included in the update file list T21, and stores the processed data in the predetermined storage device (S49).

In the present embodiment, since the offset conversion process is executed by the storage server 20A, the offset conversion process can be performed quickly.

The invention is not limited to the above-described embodiments, and can be appropriately modified and implemented without departing from the gist of the invention.

For example, although the example of extracting the data including the sensitive data in the file system is described in the above embodiments, the invention is not limited thereto, and data other than the sensitive data, for example, a predetermined word may be extracted. The data processing process is not limited to the anonymization process, and any data processing process may be performed.

Further, in the above-described embodiments, the offset is converted so as to be in the semantic recognizable range according to the type of the file, but the invention is not limited thereto, and the offset may be converted into any range that includes the range in which the operation is performed and is a part of the file.

Further, in the above embodiments, whether to perform the offset conversion is determined according to the offset conversion setting, but the invention is not limited thereto, and the offset conversion may be always performed.

What is claimed is:

1. A data processing system including one or more storage servers that store files and a data management server that executes a process on the files, the data processing system comprising:
one or more processors, wherein
the one or more processors
store respective operation contents for the files in the storage servers as an operation log,
create a snapshot of a file system in the storage servers,
extract, from the operation log, an operation content performed from creation of a previous snapshot to a current snapshot, and
create update file information capable of specifying a file updated after the creation of the previous snapshot based on the extracted operation content.

2. The data processing system according to claim 1, wherein
the operation log includes offset information indicating an operation range of a file as an operation target, and
the update file information includes offset information indicating an operation range of the updated file.

3. The data processing system according to claim 2, wherein
the processor changes the offset information to a range of a part of a file wider than the operation range.

4. The data processing system according to claim 3, wherein
the processor specifies a type of the updated file and changes the offset information to a semantic recognizable range that is a range in which a meaning is capable of being recognized based on the type.

5. The data processing system according to claim 4, wherein
the processor is configured to, when the type of the updated file is a CSV file, specify a range from a head of a row to an end of the row including the operation range as the semantic recognizable range, when the type of the updated file is a JSON file, specify a range including the operation range and surrounded by { } as the semantic recognizable range, and when the type of the updated file is a moving image file, specify a head of a key frame as a head of the semantic recognizable range.

6. The data processing system according to claim 1, wherein
the processor of the storage server creates the update file information.

7. The data processing system according to claim 1, wherein
the processor of the data management server specifies the updated file based on the update file information, acquires the updated file from the storage server, and executes a predetermined process on the updated file.

8. The data processing system according to claim 7, wherein
the processor of the data management server extracts specific data from the updated file.

9. The data processing system according to claim 8, wherein
the processor of the data management server extracts sensitive data from the updated file.

10. The data processing system according to claim 9, wherein
the processor of the data management server executes an anonymization process on the sensitive data.

11. The data processing system according to claim 1, wherein
the processor of the data management server requests the update file information from the storage server, and
when the processor of the storage server receives the request for the update file information, the processor of the storage server creates the snapshot of the file system in the storage server, extracts the operation content performed from the creation of the previous snapshot to the current snapshot from the operation log, creates the update file information capable of specifying the file updated after the creation of the previous snapshot based on the extracted operation content, and transmits the update file information to the data management server.

12. A data processing method performed by a data processing system including one or more storage servers that store files and a data management server that executes a process on the files, the data processing method comprising:
storing respective operation contents for the files in the storage servers as an operation log;
creating a snapshot of a file system in the storage servers;
extracting, from the operation log, the operation content performed from creation of a previous snapshot to a current snapshot; and
creating update file information capable of specifying a file updated after the creation of the previous snapshot based on the extracted operation content.
